(19) United States
(12) Patent Application Publication
(10) Pub. No.: US 2012/0281532 A1
(43) Pub. Date: Nov. 8, 2012

(54) METHOD AND SYSTEM FOR SELECTING A QUALITY OF SERVICE POLICY IN A UNIVERSAL PLUG AND PLAY HOME NETWORK ENVIRONMENT

(75) Inventor: Uday DHIRENDRAKUMAR TRIVEDI, Bangalore (IN)

(73) Assignee: Samsung Electronics Co., Ltd., Suwon-si (KR)

(21) Appl. No.: 13/462,361

(22) Filed: May 2, 2012

(30) Foreign Application Priority Data
May 2, 2011 (IN) 1523/CHE/2011

(51) Int. Cl. H04W 28/10

(52) U.S. Cl. 370/230

(57) ABSTRACT

A method and system are provided for selecting a Quality of Service QoS policy in a Universal Plug and Play (UPnP) home network environment. The method includes receiving a request for a QoS setup from a Control Point (CP); requesting each of at least one QoS Policy Holder (QPH) in the UPnP home network environment to provide a QoS policy for a traffic stream, based on the received request for the QoS setup; receiving at least one QoS policy from the at least one QPH according to the traffic stream; selecting a best matched QoS policy from the received at least one QoS policy, based on predefined parameters; and setting up a QoS in the UPnP home network environment by applying the selected best matched QoS policy.

### PRIORITY

This application claims priority under 35 U.S.C. §119(a) to Indian Application No. 1523/CHE/2011, which was filed in the Indian Patent Office on May 2, 2011, the entire content of which is hereby incorporated by reference.

### BACKGROUND OF THE INVENTION

1. Field of the Invention

The present invention relates generally to Universal Plug and Play (UPnP) communications, and more particularly, to selecting a Quality of Service (QoS) policy in a UPnP home network environment.

2. Description of the Related Art

UPnP is a framework for sharing digital content in a home networking scenario. QoS is broad collection of networking capabilities and techniques for improving user experience with a network's ability to deliver predictable results. UPnP QoS is a policy based UPnP architecture that allows an individual or entity to define rules based on traffic characteristics and to manage the traffic's QoS in context of the policy based system. These rules are applied to the traffic characteristics of a request to determine the QoS to be applied.

Typically, UPnP QoS architecture includes a QoS manager, a QoS Policy Holder (QPH), and a QoS Device (QD). The QoS manager receives a QoS policy request from a Control Point (CP), sends traffic stream information to the QPH and acquires a QoS policy from the QPH. Further, the QoS manager controls the QD to perform QoS configuration and setup, and QoS regulation and release when transmitting the traffic stream according to the QoS policy. The QPH obtains a corresponding QoS policy according to the traffic stream information provided by the QoS manager and sends the QoS policy to the QoS manager. The QD configures QoS policy for a traffic stream and manages QoS regulation and release under the control of the QoS manager when transmitting the traffic stream.

When a CP requests a QoS manager to setup a QoS policy for a traffic stream, the QoS manager sends traffic stream information to a QPH in order to acquire a QoS policy for the given QoS request. The QPH replies by sending the QoS policy and the related information to the QoS manager. The QoS manager uses the QoS policy to setup QoS for participating QDs.

If the QoS manager discovers a QPH in the UPnP home network, the QoS manager uses the QPH to get policy information, when the CP sends QPH information in a QoS request. However, if the QPH selected by the user/CP is not available in the UPnP home network, then the QoS manager does not setup the QoS policy and returns an error, even though another QPH might be available with a matching QoS policy.

If the CP does not send any QPH information, then the QoS manager determines whether any QPH is preferred by a user/CP for selecting a QoS policy. If there is a preferred QPH, the QoS manager requests the preferred QPH to obtain the QoS policy. If there is no preferred QPH, then the QoS manager checks if there is a single QPH on the network. If the QoS manager finds a single QPH, it uses the QPH to get a QoS policy. If none of above options works, the QoS manager applies a default QoS policy.

If there are multiple QPHs, but no preferred QPH, and if the CP does not provide QPH information in the QoS request, the QoS manager does not consult any of the QPHs and uses a default QoS policy. However, this rule invalidates the very purpose of policy based architecture, and may provide a rather annoying experience to the user as the default QoS policy is applied to the traffic stream instead of a QoS policy configured by a user on a first QPH, due to presence of a second QPH on the UPnP home network.

When multiple users access the UPnP network, different users can select different QPHs as a preferred QPH. However, the QoS manager may select a QoS policy associated with a latest preferred QPH on a UPnP home network, which may not be the preferred QPH for requesting user.

Also, when a first user has set a preferred QPH and a second user has requested a QoS policy, the QoS manager may consult the preferred QPH selected by the first user and setup the QoS based on the QoS policy provided by the preferred QPH, even if no policy rule matches the given traffic stream information in the preferred QPH.

### SUMMARY OF THE INVENTION

Accordingly, the present invention is designed to address at least the problems and/or disadvantages described above and to provide at least the advantages described below.

An aspect of the present invention is to provide an improved method and system for selecting a QoS policy in a UPnP home network environment.

In accordance with an aspect of the present invention, a method of selecting a QoS policy in a UPnP home network environment is provided. The method includes receiving a request for a QoS setup from a CP; requesting each of at least one QPH in the UPnP home network environment to provide a QoS policy for a traffic stream, based on the received request for the QoS setup; receiving at least one QoS policy from the at least one QPH according to the traffic stream; selecting a best matched QoS policy from the received at least one QoS policy, based on predefined parameters; and setting up a QoS in the UPnP home network environment by applying the selected best matched QoS policy.

In accordance with another aspect of the present invention, a non-transitory computer-readable storage medium having instructions stored therein is provided. When executed by a QoS manager, the instructions cause the QoS manager to perform a method including receiving a request for QoS setup from a CP; requesting each of at least one QPH in the UPnP home network environment to provide a QoS policy for a traffic stream, based on the received request for the QoS setup; receiving at least one QoS policy from the at least one QPH according to the traffic stream; selecting a best matched QoS policy from the received at least one QoS policy, based on predefined parameters; and setting up a QoS in the UPnP home network environment by applying the selected best matched QoS policy.

In accordance with another aspect of the present invention, an apparatus is provided, which includes a processor; and a memory including a QoS manager application for controlling the processor to receive a request for a QoS setup from a CP, request each of at least one QPH in the UPnP home network environment to provide a QoS policy for a traffic stream, based on the received request for the QoS setup, receive at least one QoS policy from the at least one QPH according to the traffic stream, select a best matched QoS policy from the received at least one QoS policy, based on predefined parameters, and set up a QoS in the UPnP home network environment by applying the selected best matched QoS policy.

In accordance with another aspect of the present invention, a system for selecting a Quality of Service (QoS) policy in a Universal Plug and Play (UPnP) home network environment is provided. The system includes a Control Point (CP); a QoS manager; a plurality of QoS policy holders (QPHs); and a plurality of QoS devices (QDs). The QoS manager receives a request for a QoS setup from the CP, requests each of the plurality of QPHs to provide a QoS policy for a traffic stream based on the received request, receives QoS polices from the plurality of QPHs according to the traffic stream, selects a best matched QoS policy from the received QoS policies based on predefined parameters, and controls operation of at least one of the plurality of QDs on the QoS of the traffic stream according to the selected best matched QoS policy. Each of the plurality of QPHs obtains a QoS policy according to the traffic stream, and sends the QoS policy to the QoS manager, The at least one of the plurality of QDs set up the QoS for the traffic stream by applying the best matched QoS policy, and operate according to the best matched QoS policy.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a UPnP home network environment for selecting a quality of service (QoS) policy, according to an embodiment of the present invention;

FIGS. 2A and 2B are flowcharts illustrating a method of selecting a QoS policy in a UPnP home network environment, according to an embodiment of the present invention; and

FIG. 3 is a block diagram illustrating a UPnP device according to an embodiment of the present invention.

### DETAILED DESCRIPTION OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

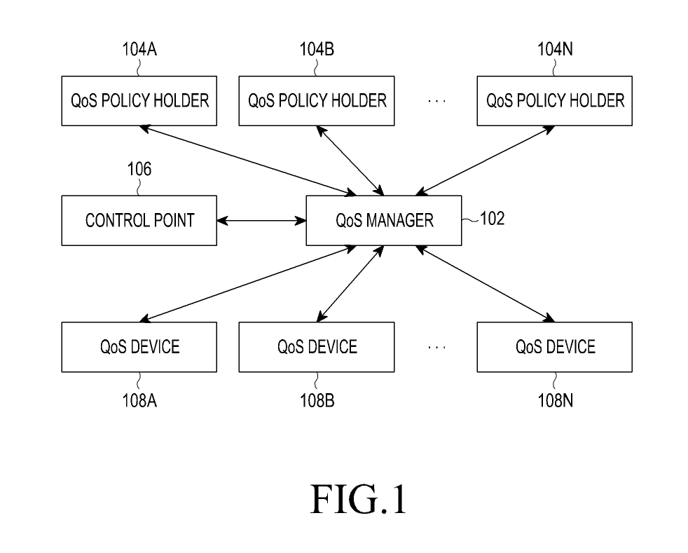

FIG. 1 illustrates a UPnP home network environment for selecting a QoS policy, according to an embodiment of the present invention.

Referring to FIG. 1, the UPnP home network environment includes a QoS manager 102, QPHs 104A-N, a CP 106, and QDs 108A-N. The QoS manager 102 receives a QoS request from the CP 106, selects at least one of QPHs 104A-N, and sends a traffic stream to the selected at least of QPHs 104A-N. The QoS manager 102 also requests each of the at least one of QPHs 104A-N to provide a QoS policy for the traffic stream, and receives QoS policies from the at least one of the QPHs 104A-N. Further, the QoS manager 102 selects a best matched QoS policy from the received QoS policies, based on predefined parameters (e.g., a username in a QoS policy, a last modified time of the QoS policy, etc.), and controls operation of at least one of the QDs 108A-N on the QoS of the traffic stream according to the selected best matched QoS policy.

Each of the QPHs 104A-N obtains a QoS policy according to the traffic stream information based on the request, and sends the QoS policy to the QoS manager 102. Each of the QDs 108A-N sets up a QoS for the traffic stream by applying a best matched QoS policy and operates as per the best matched QoS policy, when the traffic stream is transmitted under the control of the QoS manager 102.

The QoS manager 102 and the QPHs 104 can reside in the same device or the different devices.

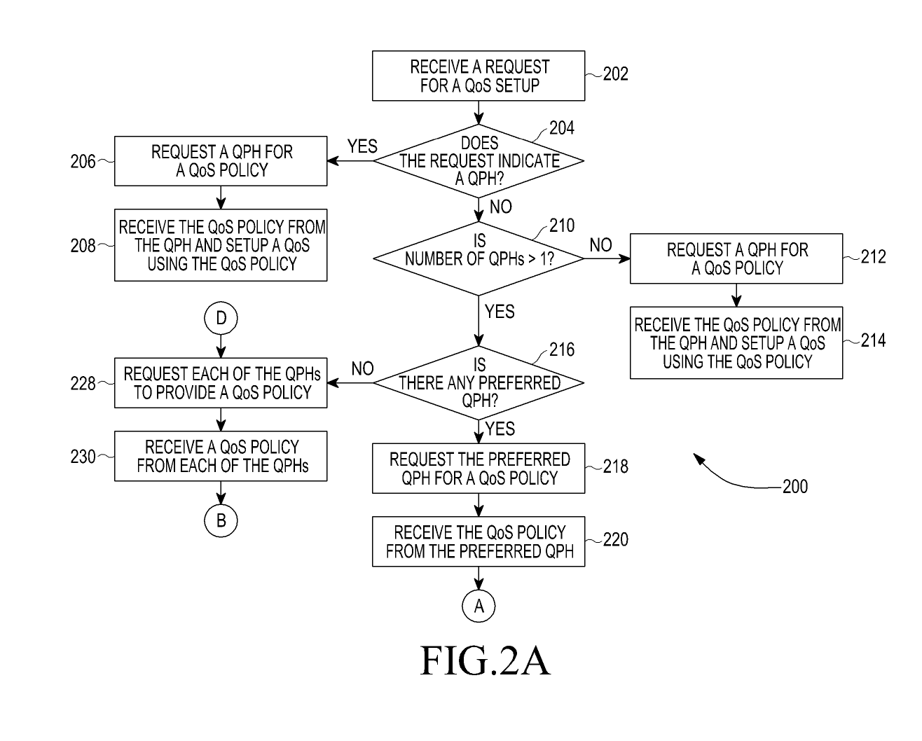

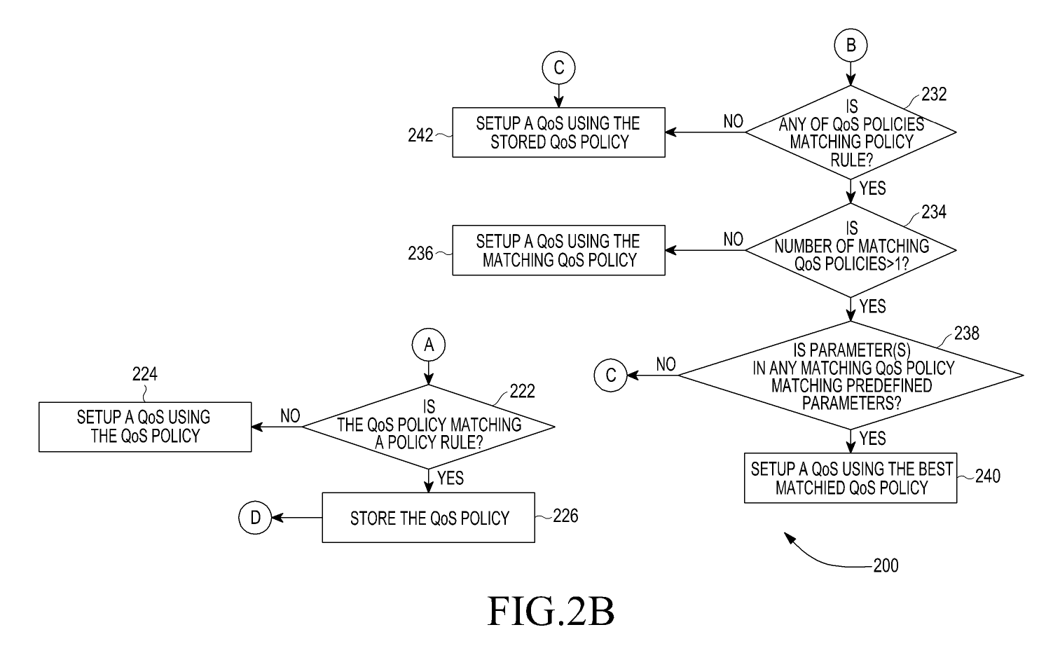

FIGS. 2A and 2B are flowcharts illustrating a method of selecting a QoS policy in a UPnP home network environment, according to an embodiment of the present invention.

Referring to FIG. 2A, in step 202, the QoS manager 102 receives a request for setting up a QoS in the UPnP home network environment from the CP 106. In step 204, the QoS manager 102 determines whether the request for setting up the QoS indicates a particular QPH. For example, the request may include a unique identifier associated with one of the QPHs in the UPnP home network environment indicated by the CP 106.

When the request indicates a particular QPH, e.g., QPH 104A, the QPH 104A is requested to provide a QoS policy for a traffic stream in step 206. In step 208, the QoS manager 102 receives the QoS policy from the QPH 104A and the QoS is setup by applying the received QoS policy.

When the request does not indicate a particular QPH in step 204, the QoS manager 102 determines whether multiple QPHs are coupled to the QoS manager 102 in the UPnP home network environment in step 210.

When there is only one QPH coupled to the QoS manager 102, e.g., QPH 104A, then QPH 104A, i.e., the one QPH, is requested to provide a QoS policy for a traffic stream in step 212. In step 214, the QoS manager 102 receives the QoS policy from QPH 104A and the QoS is setup by applying the received QoS policy.

When there are multiple QPHs coupled to the QoS manager 102 in step 210, the QoS manager 102 determines whether there is a preferred QPH in the UPnP home network environment. When there is a preferred QPH, e.g., QPH 104B, then the preferred QPH 104B is requested to provide a QoS policy for a traffic stream in step 218. In step 220, the QoS manager 102 receives the QoS policy from the preferred QPH 104B.

Referring to FIG. 2B, in step 222, the QoS manager 102 determines whether the received QoS policy matches a policy rule associated with the QoS setup requested by the CP 106. When the received QoS policy matches a policy rule associated with the QoS setup requested by the CP 106, the QoS is setup in the UPnP home network environment by applying the QoS policy received from the preferred QPH 104B in step 224. However, when the received QoS policy does not match a policy rule associated with the QoS setup requested by the CP 106, the QoS policy received from the preferred QPH 104B is stored in memory of the QoS manager 102 in step 226.

After step 226, or when the QoS manager 102 determines that there is no preferred QPH in step 216, the QoS manager 102 requests each of the QPHs 104A-N in the UPnP home network environment to provide a QoS policy for a traffic stream. In step 230, the QoS manager 102 receives QoS policies from the QPHs 104A-N.

In step 232, the QoS manager 102 determines whether any of the QoS policies received in step 230 match a policy rule associated with the QoS setup.

More specifically, whenever a QPH sends a response to a request for QoS policy, the QPH adds, for example, two types of additional information in the response. The first type of information includes a policy matched status in a policy matched field of the response. The policy matched field is a Boolean field that indicates whether any policy rule matches a given traffic descriptor in a QoS policy database. If no rule matches, the QPH sends default policy parameters to the QoS manager 102 with the policy matched status flag set as false (0). If a policy rule matches, the QPH sends a policy parameter given in the policy rule with the policy matched status flag set as true (1).

The second type of information includes a username in a policy adding username field of the response. The policy adding username field indicates a username associated with a user who added a given policy rule. Whenever a user adds a QoS policy, the QPH copies ‘username’ variable from the traffic descriptor to ‘username’ variable in QPH policy classifier structure of A_ARG_TYPE_QPH policy rule structure, indicating that a particular policy rule is added by the user identified by the username. When the QPH searches for and finds a QoS policy for a given traffic descriptor, the QPH copies the username from the matching policy rule to the policy adding username field in the A_ARG_TYPE traffic policy structure. If no username is found in the matching policy rule or default policy parameters are sent, the policy adding username field is left blank.

Referring again to FIG. 2B, when a match is found in step 232, the QoS manager 102 determines whether there are more than one QoS policies that match the policy rule in step 234. When only one QoS policy matches in step 23, a QoS is setup in the UPnP home network environment by applying the matching QoS policy in step 236. However, when more than one QoS policy matches in step 234, the QoS manager 102 determines whether at least one parameter associated with a user of the QoS setup request in any of the matching QoS policies matches predefined parameters in the traffic stream information in step 238. For example, the predefined parameters may include but are not limited to a username in a QoS policy and a last modified time of a QoS policy.

When at least one parameter associated with the user of the QoS setup request in the matching QoS policies matches predefined parameters in the traffic stream information in step 238, the matched QoS policy is selected as a best matched QoS policy and the QoS is setup in the UPnP home network environment by applying the best matched QoS policy in step 240. Thus, the QoS policy added by a user is selected for setting up a QoS requested by the user.

However, when there are no parameters associated with the user of the QoS setup request in the matching QoS policies that match predefined parameters in the traffic stream information in step 238, or when no match is found in step 232, in step 242, the QoS is setup in the UPnP home network environment by applying the QoS policy stored in step 226.

Further, in accordance with another embodiment of the present invention, a non-transitory computer-readable storage medium having instructions stored therein, when executed by a QoS manager, will cause the QoS manager to perform the method illustrated in steps 202 through 242.

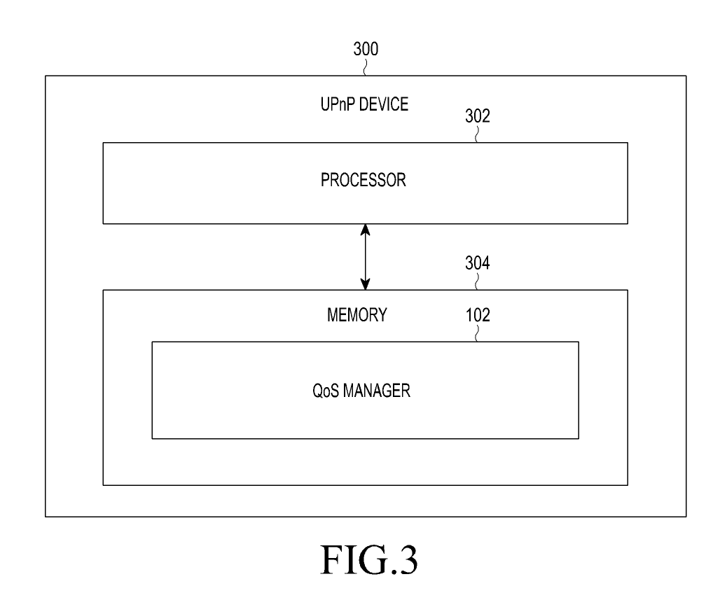

FIG. 3 is a block diagram illustrating a UPnP device according to an embodiment of the present invention.

Referring to FIG. 3, the UPnP device 300 includes a processor 302 and memory 304 coupled to the processor 302. The processor 302, as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 302 may also include embedded controllers, such as generic or programmable logic devices or arrays, application specific integrated circuits, single-chip computers, smart cards, etc.

The memory 304 may be volatile memory and non-volatile memory. Further, the memory 304 includes the QoS manager 102 in the form of instructions stored therein, which control the processor to select a QoS policy in the UPnP home network environment, according to the above-described embodiments of the present subject matter.

A variety of computer-readable storage media may be stored in and accessed from the memory 304. The memory 304 may include any suitable memory device(s) for storing data and machine-readable instructions, such as read only memory, random access memory, erasable programmable read only memory, electrically erasable programmable read only memory, hard drive, removable media drive for handling memory cards, Memory Sticks™, etc.

Embodiments of the present subject matter may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 302.

For example, a computer program may include machine-readable instructions capable of selecting a QoS policy based on predefined parameters according to the teachings and herein described embodiments of the present subject matter. The program may be included on a storage medium and loaded from the storage medium to a hard drive in the non-volatile memory. The machine-readable instructions may cause the UPnP device 300 to encode according to the various embodiments of the present invention.

Furthermore, the various devices, modules, selectors, estimators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method of selecting a Quality of Service (QoS) policy in a Universal Plug and Play (UPnP) home network environment, the method comprising:
receiving a request for a QoS setup from a Control Point (CP);
requesting each of at least one QoS Policy Holder (QPH) in the UPnP home network environment to provide a QoS policy for a traffic stream, based on the received request for the QoS setup;
receiving at least one QoS policy from the at least one QPH according to the traffic stream;
selecting a best matched QoS policy from the received at least one QoS policy, based on predefined parameters; and
setting up a QoS in the UPnP home network environment by applying the selected best matched QoS policy.

2. The method of claim 1, wherein the predefined parameters include at least one of a username in a QoS policy, and a last modified time of a QoS policy.

3. The method of claim 1, wherein requesting each of the at least one QPH in the UPnP home network environment to provide the QoS policy for the traffic stream comprises:
determining whether the request for the QoS setup indicates a particular QPH in the UPnP home network environment;
when the request for the QoS setup indicates the particular QPH, requesting the particular QPH indicated in the request for QoS setup to provide the QoS policy for the traffic stream;
when the request for the QoS setup does not indicate a particular QPH, determining whether there is more than one QPH included in the UPnP home network environment;
when there is more than one QPH included in the UPnP home network environment, determining whether there is a preferred QPH in the UPnP home network environment; and
when there only one QPH included in the UPnP home network environment, requesting the one QPH in the UPnP home network environment to provide the QoS policy for the traffic stream.

4. The method of claim 3, further comprising:
when there is the preferred QPH in the UPnP home network environment, requesting the preferred QPH to provide the QoS policy for the traffic stream; and
when there is no preferred QPH in the UPnP home network environment, requesting each of the more than one QPH included in the UPnP home network environment to provide a QoS policy for the traffic stream.

5. The method of claim 4, further comprising:
receiving the QoS policy from the preferred QPH for the traffic stream;
determining whether the QoS policy matches a policy rule associated with the QoS setup requested by the CP;
when the QoS policy matches the policy rule associated with the QoS setup requested by the CP, setting up the QoS by applying the QoS policy from the preferred QPH; and
when the QoS policy does not match the policy rule associated with the QoS setup requested by the CP, storing the QoS policy and requesting each of the more than one QPH included in the UPnP home network environment to provide a QoS policy for the traffic stream.

6. The method of claim 5, when requesting each of the more than one QPH included in the UPnP home network environment to provide the QoS policy for the traffic stream, further comprising:
receiving QoS polices from the more than one QPH according to the traffic stream;
determining whether any of the QoS policies matches a policy rule associated with the QoS setup requested by the CP;
when at least one of the QoS policies matches the policy rule, determining whether more than one of the QoS policies matches the policy rule associated with the QoS setup; and
when none of the QoS policies match the policy rule, setting up the QoS in the UPnP home network environment by applying the stored QoS policy.

7. The method of claim 6, further comprising:
when more than one of the QoS policies matches the policy rule associated with the QoS setup, determining whether at least one parameter associated with a user in each of the QoS policies matches a predefined parameter in the traffic stream;
when only one of the QoS policies matches the policy rule associated with the QoS setup, setting up the QoS in the UPnP home network environment by applying the one matching QoS policy.

8. The method of claim 7, when determining whether the at least one parameter associated with the user in each of the QoS policies matches the predefined parameter in the traffic stream, further comprising:
when the at least one parameter associated with the user in each of the QoS policies matches the predefined parameter in the traffic stream, selecting a QoS from the QoS policies as a best matched QoS policy and setting up the QoS in the UPnP home network environment by applying the best matched QoS policy; and
when no parameter associated with the user in each of the QoS policies matches the predefined parameter in the traffic stream, setting up the QoS in the UPnP home network environment by applying the stored QoS policy.

9. A non-transitory computer-readable storage medium having instructions stored therein, that when executed by a Quality of Service (QoS) manager, cause the QoS manager to perform a method comprising:
receiving a request for QoS setup from a Control Point (CP);
requesting each of at least one QoS Policy Holder (QPH) in the UPnP home network environment to provide a QoS policy for a traffic stream, based on the received request for the QoS setup;
receiving at least one QoS policy from the at least one QPH according to the traffic stream;
selecting a best matched QoS policy from the received at least one QoS policy, based on predefined parameters; and
setting up a QoS in the UPnP home network environment by applying the selected best matched QoS policy.

10. The storage medium of claim 9, wherein the method further comprises:
determining whether any of the at least one QoS policy matches a policy rule associated with the QoS setup requested by the CP;
when at least one of the at least one QoS policy matches the policy rule associated with the QoS setup requested by the CP, determining whether more than one QoS policy match with the policy rule associated with the QoS setup; and
when none of the at least one QoS policy matches the policy rule associated with the QoS setup requested by the CP, setting up the QoS in the UPnP home network environment by applying a default QoS policy.

11. The storage medium of claim 10, wherein the method further comprises:
when more than one of QoS policy matches the policy rule associated with the QoS setup, determining whether at least one parameter associated with a user in each of the QoS policies matches a predefined parameter in the traffic stream;
when only one QoS policy matches the policy rule associated with the QoS setup, setting up the QoS in the UPnP home network environment by applying the one matching QoS policy.

12. The storage medium of claim 11, wherein the method further comprises:
when the at least one parameter associated with the user in each of the QoS policies matches the predefined parameter in the traffic stream, selecting a QoS from the QoS policies as a best matched QoS policy and setting up the QoS in the UPnP home network environment by applying the best matched QoS policy; and
when no parameter associated with the user in each of the QoS policies matches the predefined parameter in the traffic stream, setting up the QoS in the UPnP home network environment by applying a default QoS policy.

13. The storage medium of claim 12, wherein the predefined parameters include at least one of a username in a QoS policy, and a last modified time of a QoS policy.

14. An apparatus comprising:
a processor; and
a memory including a Quality of Service (QoS) manager application for controlling the processor to receive a request for a QoS setup from a Control Point (CP), request each of at least one QoS Policy Holder (QPH) in the UPnP home network environment to provide a QoS policy for a traffic stream, based on the received request for the QoS setup, receive at least one QoS policy from the at least one QPH according to the traffic stream, select a best matched QoS policy from the received at least one QoS policy, based on predefined parameters, and set up a QoS in the UPnP home network environment by applying the selected best matched QoS policy.

15. The apparatus of claim 14, wherein the predefined parameters include at least one of a username in a QoS policy, and a last modified time of a QoS policy.

16. A system for selecting a Quality of Service (QoS) policy in a Universal Plug and Play (UPnP) home network environment, the system comprising:
a Control Point (CP);
a QoS manager;
a plurality of QoS policy holders (QPHs); and
a plurality of QoS devices (QDs),
wherein the QoS manager receives a request for a QoS setup from the CP, requests each of the plurality of QPHs to provide a QoS policy for a traffic stream based on the received request, receives QoS polices from the plurality of QPHs according to the traffic stream, selects a best matched QoS policy from the received QoS policies based on predefined parameters, and controls operation of at least one of the plurality of QDs on the QoS of the traffic stream according to the selected best matched QoS policy,
wherein each of the plurality of QPHs obtains a QoS policy according to the traffic stream, and sends the QoS policy to the QoS manager, and
wherein the at least one of the plurality of QDs set up the QoS for the traffic stream by applying the best matched QoS policy, and operate according to the best matched QoS policy.

17. The system of claim 16, wherein the predefined parameters include at least one of a username in a QoS policy, and a last modified time of a QoS policy.
